(19) United States
(12) Patent Application Publication
(10) Pub. No.: US 2007/0068127 A1
(43) Pub. Date: Mar. 29, 2007

(54) Cyclone apparatus, preliminary swirling unit used in the apparatus, and dust powder remover or automobile including the apparatus

(76) Inventor: Heiya Noguchi, Chiba-ken (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/234,200

(22) Filed: Sep. 26, 2005

(51) Int. Cl. B01D 45/12

(52) U.S. Cl. 55/459.1

(57) ABSTRACT

A new cyclone apparatus capable of high processing efficiency and miniaturization includes a preliminary swirling unit and a cyclone body for providing swirling movement to fluid including particular matter in powder or granular state and processing the material and the fluid. The preliminary swirling unit has an approximate cylindrical shape for providing swirling movement in same direction as swirling flow in the cyclone body to the fluid containing the material in advance, and a connecting path for discharging the fluid previously swirled in the preliminary swirling unit from the preliminary swirling unit in tangential direction and introducing the fluid to the cyclone body in tangential direction.

### BACKGROUND OF THE INVENTION

1. Field of the Invention

The present invention relates to a cyclone apparatus configured to provide swirling movement to fluid containing material in powder or granular state and to process the material and the fluid, a preliminary swirling unit used in the apparatus, and a powder dust remover or an automobile including the apparatus.

2. Description of the Related Art

A cyclone apparatus (centrifugal dust collector) for providing centrifugal force generated by swirling movement to fluid containing material in a powder or granular state and for processing the material in the fluid is widely used in many fields.

The principle of the cyclone apparatus itself was invented in the 19th century. In a general structure, a pipeline is connected to an inlet of a case body (cyclone body) which is formed an approximate cylindrical shape and stands straight. Through the pipeline, fluid containing materials in powder or granular state is introduced in a direction tangential to an interior wall of the case body so that component of swirling velocity is generated. In use of centrifugal force generated by swirling movement, particles which have higher specific gravity than fluid fall to a lower portion of the case body and are pressed to the interior wall of the case body. In addition, fluid from which material is removed is discharged from an outlet pipe standing near the center of the case body.

However, according to a conventional method in which fluid is introduced simply through a pipeline, when particulate matter is introduced into an inlet of a case body, the distribution density is substantially even because the materials which passes through the pipeline is substantially uniformly distributed in the fluid.

The turning radius of particles introduced into the central portion of the case body from the inlet is smaller than that of particles introduced into the outer side. As a result, it becomes a problem that sufficient centrifugal force is not provided to the particles introduced in the central portion of the case body, and the particles contact and disturbs the swirling flow in the case body so that the processing efficiency is reduced.

This problem is solved by maintaining the material in the case body for a sufficient time to provide the necessary centrifugal force to the particles introduced in the central side of the case body. However, such a cyclone apparatus requires a relatively long case body which may be so long that it is physically impossible to be employed in an industry in which sufficient installation space is not assured. For example, such apparatus cannot be employed as an exhaust gas processing device in an automobile.

On the other hand, focusing on such introducing condition of particulate material contained in a fluid, a centrifugal dust collector including a pipeline having a curvature in its lower part, as seen in the direction of fluid flow, is known, for example from Japanese Patent Application Laid-Open No. 6-320055.

Similarly, focusing on such introducing condition of particulate material contained in a fluid, a cyclone apparatus including a bent pipe for providing horizontal swirling movement, in the same direction as the swirling flow in the cyclone apparatus, to fluid in advance, a horizontal straight rectifier pipe connected to the bent pipe, a pipe for being connected to the horizontal straight pipe and introducing the fluid into an external pipe vorticosely from outside of the external pipe of the cyclone apparatus is known, for example, from Japanese Patent Application Laid-Open No. 10-34022.

However, according to the centrifugal dust collector described in Japanese Patent Application Laid-Open No. 6-320055, powder and granular materials are gathered into the lower part of a gas inlet, so that the height of the cyclone cannot be used effectively and the number of swirling cycles is reduced. As a result, in addition to the reduction of collecting efficiency, disturbance of gas at the inlet of the cyclone increases and its capability is not improved.

On the other hand, according to the centrifugal dust collector described in Japanese Patent Application Laid-Open No. 10-34022, by providing centrifugal force to powder and granular materials in advance of introduction into a cyclone, the powder and granular materials are gathered and introduced to a part distant from the central part of a gas inlet pipe of the cyclone. However, when the introducing speed (initial speed) of the powder and granular materials cannot be ensured, efficient centrifugal force is not provided to the powder and granular materials by simply directing them through the bent pipe. Further, when the materials contained in the powder and granular materials are fine powder dust whose mass is small, sufficient centrifugal force cannot be provided to the fine powder dust. Therefore, the introducing condition of particles contained in powder and granular materials cannot be improved.

After careful examinations for a solution of the problem, the present inventor developed an improved cyclone apparatus (hereinafter referred to as the cyclone apparatus of the present invention). The cyclone apparatus includes a cyclone body for providing a swirling movement to fluid containing materials in the powder or granular state and processing the materials and the fluid, a preliminary swirling unit an approximately cylindrical shape and providing swirling movement to in the same direction of the swirling flow in the cyclone body to the fluid containing material in advance, and a connecting path for discharging the fluid previously swirled in the preliminary swirling unit from the preliminary swirling unit in a tangential direction and introducing the fluid to the cyclone body in the tangential direction.

### SUMMARY OF THE INVENTION

According to the present invention, before the fluid containing materials in powder or granular state is introduced into the cyclone body, swirling movement is provided to the fluid. The particles in the fluid is pressed by the swirling movement to an interior wall of the preliminary swirling unit, that is, the distribution condition of the particles in the fluid is concentrated to the side of the interior wall of the preliminary swirling unit. The resulting fluid particle mixture is sequentially introduced into the cyclone body via the connecting path. With such structure, it is found that the disadvantage of the conventional cyclone apparatus, which is the processing inefficiency caused by the introducing condition of the particulate material in fluid, can be solved.

According to the cyclone apparatus of the present invention, before fluid containing material in powder or granular state is introduced into the cyclone body, swirling movement is provided to the fluid and the particles in the fluid are concentrated at to the side of the interior wall of the preliminary swirling unit. The particles introduced into the cyclone body are in an efficient condition to be processed in a short amount of time. As a result, the cyclone body can be downsized so that it may be employed in an industry in which space for installation is limited. For example, it may be employed as an exhaust gas processing device in an automobile.

According to the cyclone apparatus of the present invention, the fluid is swirled in both the preliminary swirling unit and the cyclone body. It is found that phase of noise generated in the preliminary swirling unit and phase of noise generated in the cyclone body are inverted so as to cancel each other, and the noise can be kept low.

The present invention has been completed based on the above findings and a material of the invention is to provide a new cyclone apparatus capable to realize high processing efficiency and miniaturization, a preliminary swirling unit used in the apparatus, and a powder dust remover or an automobile using the apparatus.

### BRIEF DESCRIPTION OF THE DRAWINGS

The foregoing and other features of the invention will become apparent from the detailed description contained herein below, taken in conjunction with the drawings, in which:

FIG. 1 is a diagram showing a cyclone apparatus of the present invention;

FIGS. 2A and 2B are diagrams showing a material distribution condition in fluid in a connecting path of the cyclone apparatus of the present invention;

FIG. 3 is a diagram showing another cyclone apparatus of the present invention;

FIG. 4 is a diagram showing another cyclone apparatus of the present invention;

FIG. 5 is a diagram showing another cyclone apparatus of the present invention; and

FIG. 6 is a cross-sectional diagram showing a cyclone body employed in another cyclone apparatus.

### DESCRIPTION OF THE PREFERRED EMBODIMENTS

As a means to solve the problem, a cyclone apparatus of the present invention includes a cyclone body or housing, for providing swirling movement to fluid containing material in the powder or granular state and processing the material and fluid, a preliminary swirling unit with an approximate cylindrical shape for providing swirling movement in the same direction as that of the swirling flow in the cyclone body to the fluid containing materials in advance, and a connecting path for discharging the fluid previously swirled in the preliminary swirling units from the preliminary swirling unit in a tangential direction and introducing the fluid to the cyclone body in a tangential direction.

A cyclone apparatus of the present invention, a preliminary swirling unit used in the apparatus, and a powder dust remover or an automobile having the apparatus will be described in detail.

Fluid containing material in the powder or granular state, as a material to be processed by the cyclone apparatus of the present invention, is a material that flows freely in the cyclone apparatus without accumulating and should not be limited. It may be in liquid or gas state.

Concretely, it may be, for example, exhaust gases or the like exhausted in various industries such as a manufacturing, electricity generating, construction, waste disposal, or an agricultural industry, or exhaust gases or the like exhausted from various means of transportation such as bikes, automobiles, trucks, busses, locomotives and ships.

The cyclone apparatus of the present invention is to process such fluid containing materials in powder or granular state, and includes a cyclone body, a preliminary swirling unit and a connecting path.

The cyclone body included in the cyclone apparatus of the present invention should not be limited and a conventional cyclone using a principle of processing materials such as powder dust in use of centrifugal force generated by swirling fluid can be employed. Generally, a cyclone is employed, which has an approximate cylindrical body for fluid swirling, an approximate conical lower body portion for collecting and/or discharging particulate from the bottom part of the body, a fluid outlet pipe, and a connecting unit which is explained below.

According to the cyclone apparatus of the present invention, before fluid containing material in powder or granular state is introduced into the cyclone body, swirling movement is provided to the fluid, and the material in the fluid is gathered to the side of the interior wall of the preliminary swirling unit. The material introduced into the cyclone body is in an efficient condition to be processed in a short amount of time. With such structure, the cyclone body can be downsized.

Therefore, the cyclone body used in the cyclone apparatus of the present invention may be shorter than the conventional cyclone. That is, the cyclone body which is short in the vertical length may be used preferably. By applying such shorter cyclone body, the cyclone apparatus of the present invention may be employed in an industry in which installation space is not assured and in which a conventional cyclone can not be applied. For example, it may be used as an exhaust gas processing device in automobiles.

The vertical length of the cyclone body can be determined according to the applying field or the acceptable installing space, and it should not be limited. Generally, it is preferable that the length is set 1 to 5 times longer than the average diameter of the approximate cylindrical body for swirling fluid. Further, it is more preferable that the length is set 1.5 to 3 times longer than the average diameter of the body.

It is preferable that the vertical length of the cyclone body not be set shorter than the average diameter of the approximate cylindrical body for swirling fluid because efficient swirling movement cannot be provided to the fluid. Also, it is preferable that the vertical length of the cyclone body not be set more than 5 times longer than the average diameter of the approximate cylindrical body for swirling fluid because the cyclone body becomes very long in vertical direction and the applying field may be limited.

The approximate cylindrical shape is intended to not only include a literally cylindrical shape (circular cylinder) in which the top diameter and the bottom diameter are the same, but also a shape such as circular cone which is cut in a horizontal face (campanulate shape or inverted campanulate shape), for example. In short, the approximate cylindrical shape used for the cyclone apparatus of the present invention represents any kind of hollow shapes in which fluid is swirled smoothly without accumulating. In other words, it represents all hollow shapes having a circular horizontal cross section.

Therefore, the average diameter h represents an average value of diameters of the body from the upper part to the bottom part.

The term approximate conical shape is intended to mean not only include a literally circular cone shape but also a hemispheric shape, a cone-shaped hollow, a centroclinal shape or the like. In short, approximate conical bottom portion of the body is continuously provided to the approximate cylindrical body for swirling fluid and includes any kinds of hollow shapes in which its diameter changes smaller gradually in lower part of the cyclone body.

According to the cyclone apparatus of the present invention, before fluid containing material in powder or granular state is introduced into the cyclone body, swirling movement is provided to the fluid and the material in the fluid is gathered to the side of the interior wall of the preliminary swirling unit. The material in fluid is pressed by centrifugal force to the interior wall of the preliminary swirling unit, that is, the distribution condition of the material in fluid is gathered to the side of the interior wall of the preliminary swirling unit. Fluid which is made in such condition is introduced into the cyclone body via the connecting path. This is an important feature of the present invention.

According to the cyclone apparatus of the present invention, swirling movement is provided to fluid in the preliminary swirling unit and the material particles in the fluid are gathered to the side of the interior wall of the preliminary swirling unit. Fluid which is produced in such condition is sequentially introduced into the cyclone body so that the material in fluid introduced to the cyclone body is in an efficient condition to be processed in a small amount of time.

The preliminary swirling unit used in the cyclone apparatus of the present invention has an approximate cylindrical body, a fluid inlet for introducing the fluid into the body in a tangential direction, and a connecting path which is described later. The preliminary swirling unit is a unit to swirl fluid promptly without accumulating and it should not be limited.

The approximate cylindrical shape is intended to mean not only a circular cylinder having a uniform diameter but also a shape such as circular cone which is cut in a horizontal face (campanulate shape or inverted campanulate shape), for example. In short, the approximate cylindrical used for the cyclone apparatus of the present invention represents any kind of hollow shapes in which fluid is swirled promptly without accumulating. In other words, it represents all hollow shapes having a circular horizontal cross section.

It is preferable that the interior wall of the preliminary swirling unit is smooth with few concavities and convexities because extreme concavities and convexities on the interior wall of the preliminary swirling unit may disturb the swirling flow.

However, according to the present invention, it is preferable that the diameter of the preliminary swirling unit is made to change gradually smaller from the portion where an inlet is formed to the portion where the connecting path, explained later, is formed. With such structure, the swirling speed of the fluid introduced into the preliminary swirling unit can be accelerated until it reaches to the connecting path. As a result, efficient centrifugal force can be provided to the material contained in the fluid.

The vertical length of the preliminary swirling unit can be determined according to the applying field or the acceptable installing space, and it should not be limited. Generally, it is preferable that the length is set 1 to 5 times longer than the average diameter of the approximate cylindrical body for swirling fluid. Further, it is more preferable that the length is set 1.5 to 3 times longer than the average diameter of the body.

It is preferable that the vertical length of the preliminary swirling unit not be set shorter than the average diameter of the approximate cylindrical body for swirling fluid because efficient swirling movement cannot be provided to fluid. Also, it is preferable that the vertical length of the preliminary swirling unit not be set more than 5 times longer than the average diameter of the approximate cylindrical body for swirling fluid because the preliminary swirling unit becomes very long in vertical direction and the applying field is limited.

The average diameter represents an average value of diameters of the body from the upper part to the bottom part.

According to the cyclone apparatus of the present invention, before fluid containing material in powder or granular state is introduced into the cyclone body, swirling movement is provided to the fluid and the material in fluid is gathered to the side of the interior wall of the preliminary swirling unit. The material in fluid is pressed to an interior wall of the preliminary swirling unit, that is, the distribution condition of the materials in fluid is gathered to the side of the interior wall of the preliminary swirling unit. Fluid resulting in such condition is introduced into the cyclone body via the connecting path.

In other words, in the cyclone apparatus of the present invention, swirling movement is provided to fluid in the preliminary swirling unit in advance. Fluid in condition that material in the fluid is gathered to the side of the interior wall of the preliminary swirling unit is introduced into the cyclone body. As a result, an efficient swirling movement can be provided to fluid even when introducing speed (initial speed) for introducing fluid is not ensured. Further, efficient centrifugal force can be provided to particles even when the material in fluid is fine powder dust, and the introducing condition of material in fluid to the cyclone body can be improved.

The connecting path for connecting the cyclone body and the preliminary swirling unit is a path for discharging fluid previously swirled in the preliminary swirling unit from the preliminary swirling unit in tangential direction and introducing the fluid into the cyclone body in a tangential direction, and it should not be limited. However, it is preferable that the connecting path linearly connect the cyclone body and the preliminary swirling unit to maintain the distribution condition of the material in fluid, which is gathered in the preliminary swirling unit, and to minimize or prevent resistance (impact) given to the fluid drained form the preliminary swirling unit.

According to the cyclone apparatus of the present invention, it is preferable that the connecting path have a flat interior wall at least in the outer side of the apparatus, that is, a greater density side of the material distribution in fluid when the fluid passes through the connecting path. With such structure, diffusion of material in the connecting path can be prevented and the distribution of the material in fluid, which is gathered in the preliminary swirling unit, can be maintained.

As described above, the cyclone apparatus of the present invention includes a cyclone body, a preliminary swirling unit, and a connecting path. However, each element is not limited and more than one unit may be provided for each element. In some situations, another cyclone body (sub-cyclone), another preliminary swirling unit, or another connecting path for connecting those elements may be provided.

In other words, there may be situations in which the amount of fluid flow from the preliminary swirling unit to the cyclone body is excessive so that it cannot pass through the connecting path promptly, or that the capacity of fluid flow exceed the processing amount of the cyclone body so that some excess fluid which cannot be introduced into the cyclone body overflows. Those situations are caused in conditions wherein a large amount of fluid is to be processed, or the amount of introduced fluid is not constant. However, according to the cyclone apparatus of the present invention, it is preferable that a sub-cyclone is provided for processing fluid which cannot be introduced to the cyclone body (overflowed fluid) in addition to the cyclone body to avoid overflow situations.

The sub-cyclone is connected to the preliminary swirling unit via a different connecting path from that which connects the cyclone body. However, the sub-cyclone and the cyclone body are connected to the preliminary swirling unit in the same manner. Therefore, to avoid repetition, those explanations are omitted here. According to the cyclone apparatus of the present invention, a further sub-cyclone may be provided if required. By providing a plurality of sub-cyclones, overflow situations may be prevented and processing amount in the apparatus can be increased.

On the other hand, when the introducing speed (initial speed) for introducing fluid is extremely slow, or the height of the preliminary swirling unit is not enough because the installing space is limited in the cyclone apparatus, it is difficult to provide efficient swirling movement to fluid introduced into the preliminary swirling unit from a fluid inlet pipe.

In such situation, according to the present invention, a plurality of preliminary swirling units are serially connected so that time can be maintained to provide efficient swirling movement to the fluid introduced into the preliminary swirling units from a fluid inlet pipe.

Especially, for the plurality of preliminary swirling units used in this case, it is preferable that the diameter of the preliminary swirling unit is made to change gradually smaller from the portion where the inlet is formed to the portion where the connecting path, explained later, is formed. In use of preliminary swirling units having such structure, efficient centrifugal force can be provided to the material in fluid while the fluid is passing through the plurality of preliminary swirling units even when introducing speed (initial speed) for introducing fluid is extremely slow.

The plurality of preliminary swirling units are serially connected via connecting paths. However, they are connected the same manner as the above connecting path for connecting the cyclone body and the preliminary swirling unit. Therefore, to avoid repetition, those explanations are omitted here.

According to the cyclone apparatus of the present invention, the average diameters for each of the approximate cylindrical body for swirling fluid in the cyclone body and the approximate cylindrical body of the preliminary swirling unit may be determined according to the applying field or the acceptable installing space, and they should not be limited.

However, according to the cyclone apparatus of the present invention, fluid is swirled in both of the preliminary swirling unit and the cyclone body. It is found that the noise generated in the preliminary swirling unit and the noise generated in the cyclone body cancel each other and the noise can be kept low. Especially, it is found that generated noise becomes smallest in the condition that the phase of noise generated in the preliminary swirling unit and phase of noise generated in the cyclone body are inverted.

The condition that the phase of noise generated in the preliminary swirling unit and the phase of noise generated in the cyclone body are inverted can be achieved when the average internal diameters of the approximate cylindrical body for swirling fluid in the cyclone body and the approximate cylindrical body in the preliminary swirling unit are set almost the same. Therefore, it is preferable that, when the average internal diameter of the approximate cylindrical body for swirling fluid in the cyclone body is set at 1, the average internal diameter of the approximate cylindrical body in the preliminary swirling unit is set to 1±0.2. It is more preferable that it is adjusted to 1±0.1.

Further, in case where a plurality of preliminary swirling units are serially connected, the same noise reduction effects as mentioned above can also be achieved when the average internal diameters of the approximate cylindrical body for swirling fluid in the cyclone body and the approximate cylindrical body in the preliminary swirling unit are set almost the same. Therefore, in this case, it is preferable that, when the average internal diameter of the approximate cylindrical body for swirling fluid in the cyclone body is set at 1, the average internal diameter of the approximate cylindrical body in the preliminary swirling unit is set to 1±0.2, more preferably 1±0.1.

On the other hand, it is found that, in the case that a sub-cyclone is provided and the average internal diameters of the approximate cylindrical body for swirling fluid in the cyclone body and the approximate cylindrical body for swirling fluid in the sub-cyclone apparatus are set almost the same, noise generated in the cyclone body and noise generated in the sub-cyclone emphasize each other. As a result, it is found that the noise becomes larger.

Therefore, according to the cyclone apparatus of the present invention, when one or more sub-cyclones are provided, the average internal diameters of the approximate cylindrical body for swirling fluid in the cyclone body and the approximate cylindrical body in the sub-cyclone are set differently. In detail, when the average internal diameter of the cyclone body is set at 1, the average internal diameter of the sub-cyclone is set to 1±0.2 so that the phases of noise generated in each becomes different so that each noise does not accentuate each other.

As described above, the cyclone apparatus of the present invention is for providing swirling movement to the fluid in the preliminary swirling unit and the material in fluid are gathered to the side of the interior wall of the preliminary swirling unit and processing the fluid and the material in the cyclone body.

Here, among material, especially, powder dust is rubbed on the interior walls and burned off during the swirling movement in the preliminary swirling unit and the cyclone body. It finally changes into gas such as carbon dioxide.

Accordingly, when the cyclone apparatus of the present invention processes material contained in fluid, which is mostly fine powder dust such as contained in exhaust gas of an automobile, most of the fine powder dust contained in the exhaust gas is burned out during swirling movement in the preliminary swirling unit and the cyclone body. Then, the particles are converted into gas so as to be discharged with fluid.

However, some fine powder dust which remains without being burned out is gathered to the bottom portion of the cyclone body or the like (the cyclone body and/or the sub-cyclone). Here, when a predetermined amount of the fine powder dust is accumulated, they have to be removed.

According to the cyclone apparatus of the present invention, it is preferable that the particles gathered in the cyclone body and/or the sub-cyclone may be reintroduced to the preliminary swirling unit as required. With such structure, the collected material particles which remain without being burned off can be swirled again in the preliminary swirling unit and the cyclone body to be converted into gas. As a result, an operation of removing the collected fine powder dust can be omitted. It realizes what is called maintenance-free.

It should not be limited as a means for reintroducing the collected material to the preliminary swirling unit. Concretely, for example, the powder dust may be collected by collecting means such as a rocker valve at the bottom part of the cyclone body. With the operation of the rocker valve or the like, the collected powder dust may be led to a reintroducing pipe which is connected to the preliminary swirling unit. The powder dust may be reintroduced to the preliminary swirling unit via the reintroducing pipe.

preliminary swirling unit of the present invention has the above structure and employed in the cyclone apparatus of the present invention. The processing efficiency of a conventional cyclone body can be remarkably improved by connecting the preliminary swirling unit with the conventional cyclone body.

A powder dust remover of the present invention is a new powder dust remover including the cyclone apparatus of the present invention. The powder dust remover is distinguished so that processing efficiency is increased, the cyclone apparatus of the present invention can be downsized, and the noise is kept low.

An automobile of the present invention may include the cyclone apparatus of the present invention. Its exhaust gas is processed with the cyclone system although it had previously been impossible because the installation space could not be ensured. Because of the sound deadening effect of the cyclone apparatus of the present invention, a sound reducing device such as a muffler is not required to be installed and a maintenance-free mechanism is achieved.

The cyclone apparatus of the present invention includes a cyclone body for providing swirling movement to fluid containing material in powder or granular state and processing the material and the fluid, a preliminary swirling unit being formed in an approximate cylindrical shape and providing swirling movement in the same direction of the swirling flow in the cyclone body to fluid containing particulate material in advance, a connecting path for discharging fluid previously swirled in the preliminary swirling unit from the preliminary swirling unit in a tangential direction and introducing the fluid to the cyclone body in a tangential direction.

In other words, according to the cyclone apparatus of the present invention, before fluid containing material in powder or granular state is introduced into the cyclone body, swirling movement is provided to the fluid and the material in the fluid are gathered to the side of the interior wall of the preliminary swirling unit. Fluid which is made in such condition is introduced sequentially into the cyclone body. With such structure, the disadvantage of the conventional cyclone apparatus, which is a processing inefficiency caused by the introducing condition of the material in fluid, can be solved.

According to the cyclone apparatus of the present invention, before fluid containing material in powder or granular state is introduced into the cyclone body, swirling movement is provided to the fluid, and the material in the fluid is concentrated at the side of the interior wall of the preliminary swirling unit. The material in fluid introduced into the cyclone body can be in an efficient condition to be processed in a short amount of time. As a result, the cyclone body can be downsized and may be employed in an industry in which space for installation is not assured. For example, it may be employed as an exhaust gas processing device in an automobile.

According to the cyclone apparatus of the present invention, the fluid is swirled in both the preliminary swirling unit and the cyclone body. It is found that the phase of noise generated in the preliminary swirling unit and phase of noise generated in the cyclone body are inverted so as to cancel each other and the noise can be kept low.

A powder dust remover of the present invention is a new powder dust remover including the cyclone apparatus of the present invention. The powder dust remover is distinguished so that processing efficiency is increased, the cyclone apparatus of the present invention can be downsized, and the noise is kept low.

An automobile of the present invention includes the cyclone apparatus of the present invention. Its exhaust gas is processed with a cyclone system although it has previously been impossible because the installation space could not be ensured. Because of the sound deadening effect of the cyclone apparatus of the present invention, a sound reducing device such as a muffler is not required to be installed and a maintenance-free mechanism is achieved.

Examples of the present invention will be described. It is noted that the present invention should not be limited thereto.

### EXAMPLE 1

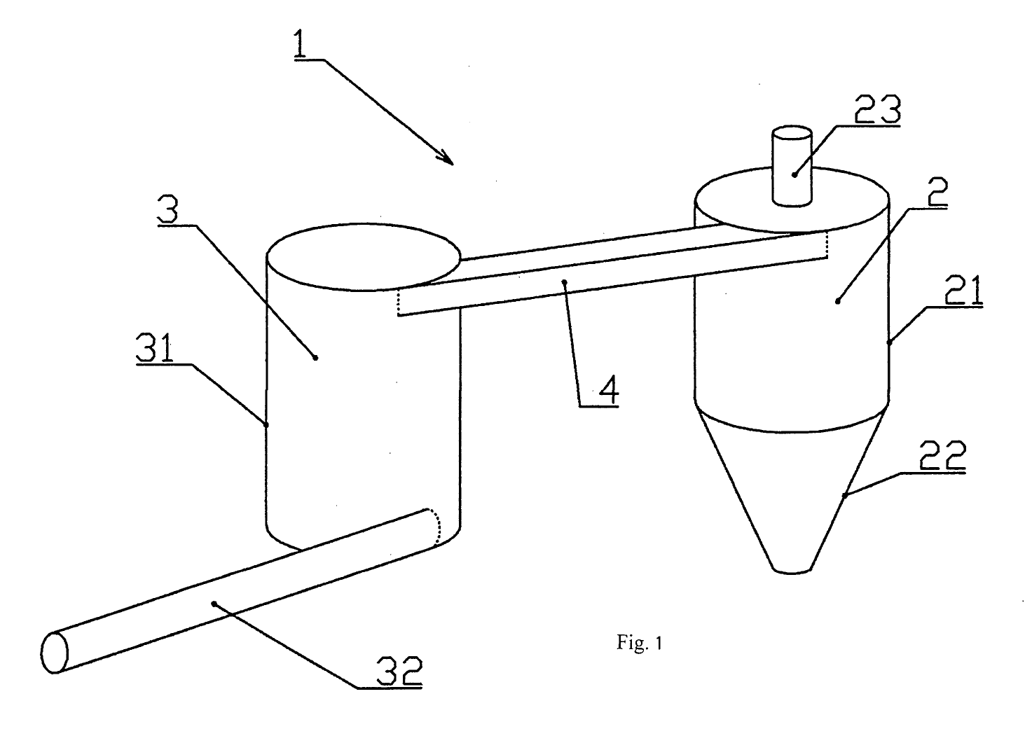

FIG. 1 is a diagram showing a cyclone apparatus 1 of the present invention. The apparatus 1 includes a cyclone body 2, a preliminary swirling unit 3 and a connecting path 4.

The cyclone body 2 includes an approximate cylindrical body 21 for swirling fluid, an approximate conical lower body portion 22, and a fluid outlet pipe 23. The cyclone body 2 employs a principle of processing material, such as powder dust, in the use of centrifugal force which is generated by swirling fluid tangentially introduced from the connecting path 4.

The preliminary swirling unit 3 includes an approximate cylindrical body 31, a fluid inlet pipe 32 for tangentially introducing fluid into the body 31. The preliminary swirling unit 3 is configured to introduce fluid to the cyclone body 2 via the connecting path 4. The fluid is tangentially introduced from the fluid inlet pipe 32 to be swirled. In use of the centrifugal force, distribution of material in the fluid is concentrated at the side of the interior wall of the preliminary swirling unit 3. Fluid which is produced in such condition is introduced sequentially.

As a connecting path 4 connecting the cyclone body 2 and the preliminary swirling unit 3, a preferably straight rectangular or square pipe is used to prevent a diffusion of the gathered material in the preliminary swirling unit 3, in other words, to maintain the particle distribution condition.

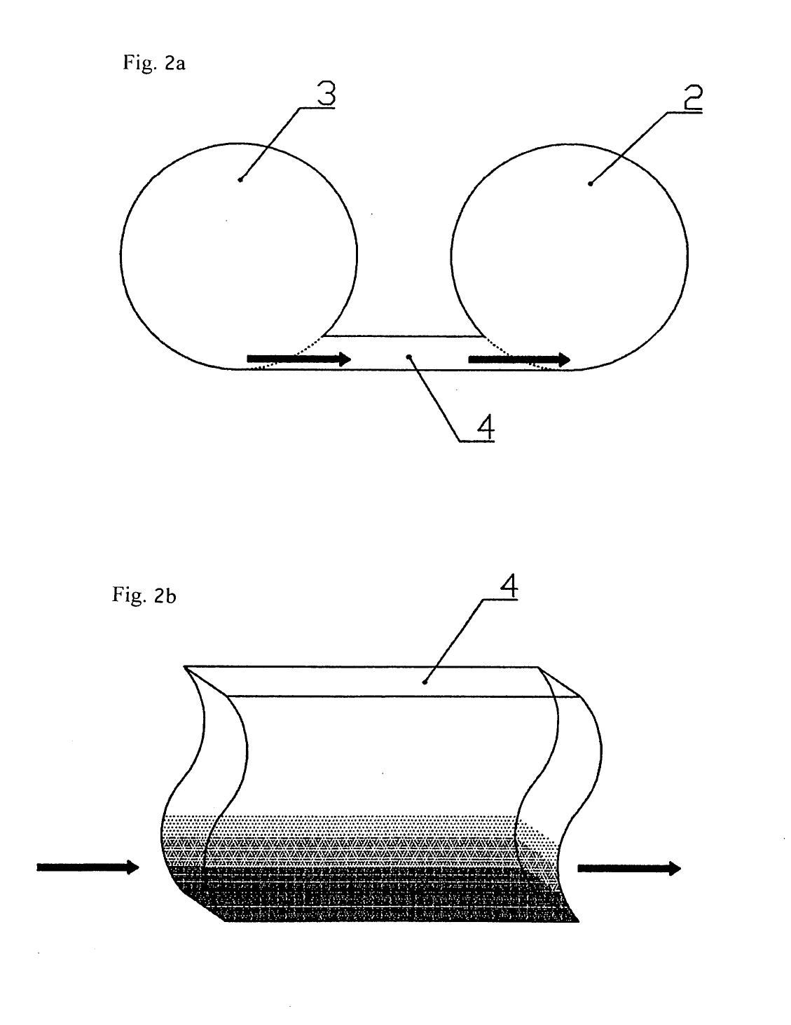

FIG. 2A is a diagram showing a particulate material condition in fluid passing through the connecting path 4 of the cyclone apparatus 1 of the present invention. FIG. 2B is an overhead transparent diagram showing a part of the connecting path 4 in the condition of FIG. 2A.

As shown in FIG. 2A, particles in fluid which is gathered at the side of the interior wall of the preliminary swirling unit 3 by swirling movement are introduced to the connecting path 4 from the preliminary swirling unit 3.

When the material in fluid is introduced to the connecting path 4, the condition that the material is gathered at the outer sidewall in the connecting path 4 is maintained as shown in FIG. 2B even though its vector is changed to a straight line direction.

Fluid is introduced into the cyclone body 2 while maintaining the condition that the particles are concentrated at the outer sidewall in the connecting path 4.

In other words, in the cyclone apparatus 1 of the present invention, swirling movement is provided to fluid in advance in the preliminary swirling unit 3. Fluid in condition that particle in the fluid are gathered at the outer sidewall of the preliminary swirling unit 3 is introduced into the cyclone body 2. The distribution condition of the particles in fluid introduced into the cyclone body 2 is efficient to be processed in a short amount of time. As a result, the cyclone body 2 can be downsized, and an efficient swirling movement can be provided to fluid even when a high introducing speed (initial speed) for introducing fluid is not ensured. Further, efficient centrifugal force can be provided to particles even when the material in fluid is fine powder dust, and the introducing condition of the material in fluid to the cyclone body 2 can be improved.

In this Example, when the average internal diameters of the approximate cylindrical body 21 for swirling fluid in the cyclone body 2 and an approximate cylindrical body 31 in the preliminary swirling unit 3 are set about the same, phase of noise generated in the preliminary swirling unit 3 and phase of noise generated in the cyclone body 2 are inverted so as to cancel each other and the noise can be kept low.

### EXAMPLE2

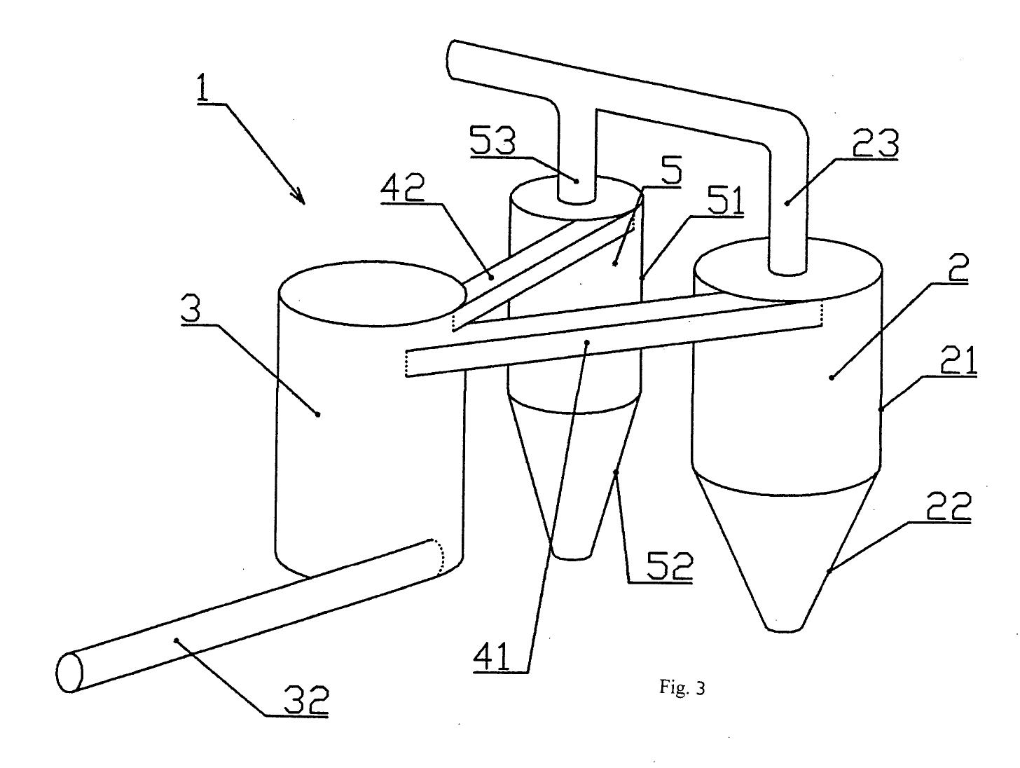

FIG. 3 is a diagram showing a cyclone apparatus 1 of another embodiment of the present invention. The apparatus 1 includes a cyclone body 2, a sub-cyclone 5, a preliminary swirling unit 3 and connecting paths 41, 42.

The cyclone apparatus 1 shown in FIG. 3 has the same structure as Example 1 except that it includes the sub-cyclone 5 in addition to the cyclone body 2. It prevents situations such as when the amount of fluid flow from the preliminary swirling unit 3 to the cyclone body 2 is in excess so that it cannot passes through the connecting path 41 promptly, and that the amount of fluid flow exceeds the processing amount of the cyclone body 2 so that some excess fluid which cannot be introduced into the cyclone body 2 overflows. Those situations are caused in condition that a large amount of fluid is to be processed, or that the introducing amount of fluid is not constant.

The cyclone body 2, the preliminary swirling unit 3 and the connecting paths 4 employed in this Example can be the same as those explained in Example 1. Therefore, to avoid repetition, those explanations are omitted here.

The sub-cyclone 5 of this Example is connected to the preliminary swirling unit 3 via the connecting path 42 similar to the connecting path 41. Thus, to avoid repetition, its explanation is omitted here.

The sub-cyclone 5 includes an approximate cylindrical body 51 for swirling fluid, an approximate conical lower body portion 52, and a fluid outlet pipe 53. The sub-cyclone 5 employs a principle of processing material, such as powder dust, by using centrifugal force which is generated by swirling fluid tangentially introduced from the connecting path 42. A device similar to the cyclone body 2 may be applied as the sub-cyclone 5. However, in this Example, the average internal diameters of the approximate cylindrical body 21 for swirling fluid in the cyclone body 2 and the approximate cylindrical body 51 in the sub-cyclone 5 are set differently. As a result, phases of noises generated in each of them become different to prevent the noises from accentuating each other.

### EXAMPLE 3

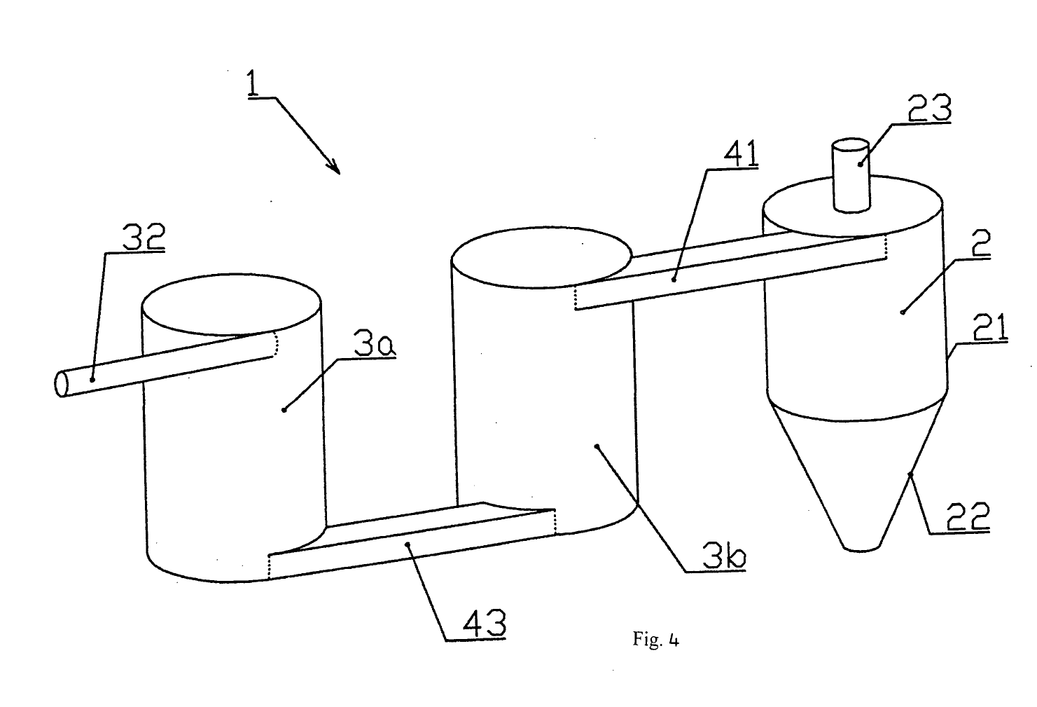

FIG. 4 is a diagram showing a cyclone apparatus 1 of another embodiment of the present invention. The apparatus 1 includes a cyclone body 2, a first preliminary swirling unit 3a, a second preliminary swirling unit 3b, and connecting paths 41, 43.

The cyclone apparatus 1 shown in FIG. 4 has the same structure as Example 1 except that it includes two (or more) preliminary swirling units, the first preliminary swirling unit 3a and the second preliminary swirling unit 3b, which are serially connected. With this structure, sufficient time for providing efficient swirling movement to fluid introduced into the preliminary swirling units from a fluid inlet pipe 32 can be ensured in case that introducing speed (initial speed) for introducing fluid is extremely slow, or in case that the height of the preliminary swirling units is not enough.

The cyclone body 2, the preliminary swirling units (the first preliminary swirling unit 3a and the second preliminary swirling unit 3b), and the connecting paths 41, 43 employed in this Example can be the same as those explained in Example 1. Therefore, to avoid repetition, those explanations are omitted here.

The first preliminary swirling unit 3a and the second preliminary swirling unit 3b are serially connected via the connecting path 43. Here, the connecting paths 43 can be the same as a connecting path 41 which connects the second preliminary swirling unit 3b and the cyclone body 2. Therefore, to avoid repetition, its explanation is omitted here.

### EXAMPLE 4

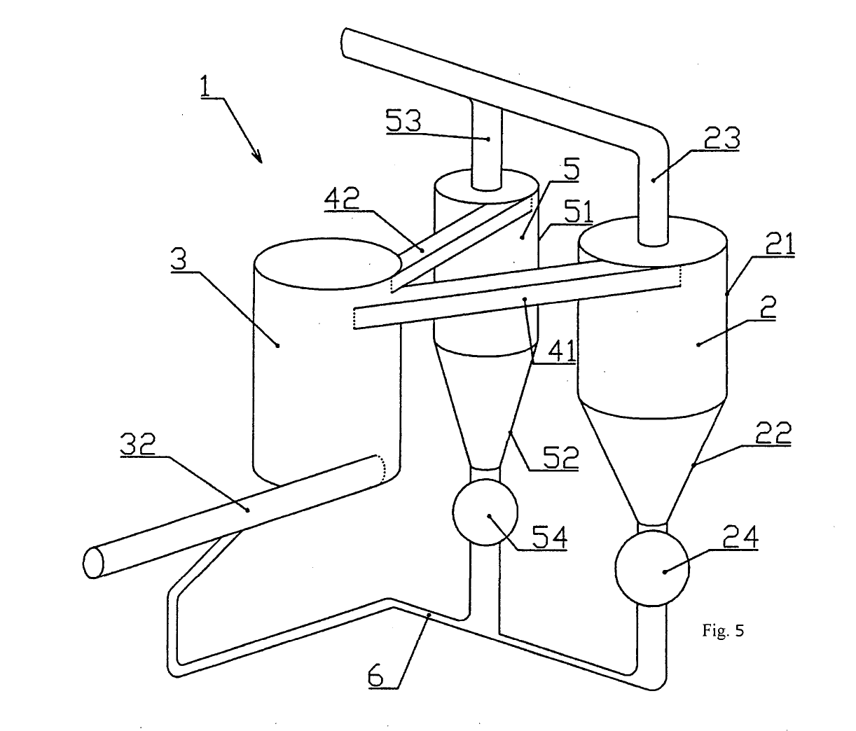

FIG. 5 is a diagram showing a cyclone apparatus 1 of another embodiment of the present invention. The apparatus 1 includes a cyclone body 2, a sub-cyclone 5, a preliminary swirling unit 3, connecting paths 41, 42, and a reintroducing pipe 6.

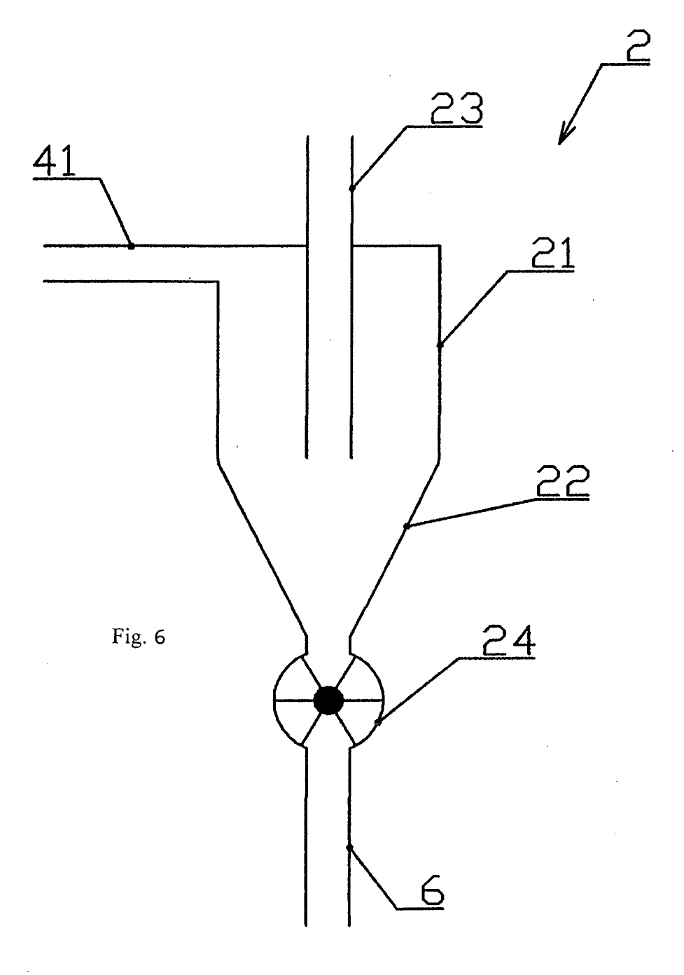

The cyclone body 2 (and the sub-cyclone 5), as shown in a sectional diagram of FIG. 6, includes an approximate cylindrical body 21 (51) for swirling fluid, an approximate conical lower body portion 22 (52), a fluid outlet pipe 23 (53), and a rocker valve 24(54). The cyclone body 2 employs a principle of processing material, such as powder dust, by using centrifugal force which is generated by swirling fluid tangentially introduced from the connecting path 41(42). Particularly, collected materials are collected in the rocker valve 24(54), and, by the operation of the rocker valve 24(54), the collected materials are brought to the reintroducing pipe 6 which is connected with the preliminary swirling unit 3. The collected materials are reintroduced to the preliminary swirling unit 3 via the reintroducing pipe 6.

In other words, the cyclone apparatus 1 shown in FIG. 5 has the same structure as Example 3, except for that it employs the cyclone body 2 (and sub-cyclone 5) having the rocker valve 24(54) in its bottom portion and includes the reintroducing pipe 6 for reintroducing the collected material in the rocker valve 24(54) into the preliminary swirling unit 3. Particularly, when most of the materials in fluid are fine powder dust, such as exhaust gas from an automobile, the material can be completely burned off by swirling in the preliminary swirling unit 3, the cyclone body 2 or the like. As a result, an operation for removing the collected fine powder dust can be omitted, and a maintenance-free mechanism is achieved.

The preliminary swirling unit 3 and the connecting paths 4 can be the same as those explained in Example 1. Therefore, to avoid repetition, those explanations are omitted here.

Further, the reintroducing pipe 6 is connected to a fluid inlet pipe 32 in a manner to reduce the pressure inside of the reintroducing pipe 6 by the velocity of new fluid introduced through the fluid inlet pipe 32. As a result, the materials brought to the reintroducing pipe 6 from the rocker valve 24(54) can be promptly introduced by suction into the fluid inlet pipe 32.

A cyclone apparatus of the present invention includes a cyclone body for providing swirling movement to fluid containing material in powder or granular state and processing the material and fluid, a preliminary swirling unit in an approximate cylindrical shape and providing swirling movement in the same direction of the swirling flow in the cyclone body to the fluid containing particulate matter in advance, and a connecting path for discharging fluid previously swirled in the preliminary swirling unit from the preliminary swirling unit in a tangential direction and introducing the fluid to the cyclone body in a tangential direction. The cyclone apparatus of the present invention can preferably process exhaust gases or the like exhausted in various industries such as a manufacturing, electricity generating, construction, waste disposal, or an agricultural, or exhaust gases or the like exhausted from various means of transportation such as bikes, automobiles, trucks, busses, locomotives, and ships. Therefore, the cyclone apparatus of the present invention can be applied not only to powder dust removers or automobiles but also kitchen instruments, smokeless roasters, ash collectors, air purification systems, clean room equipments, exhaust gas treatment devices for ships, construction machines, agricultural instruments, steam locomotives, diesel locomotives, garbage disposals, spin-dryers, sawdust separators for lumber sawing, or leather waste segregators.

The foregoing relates to preferred exemplary embodiments of the invention, it being understood that other variants and embodiments thereof are possible within the spirit and scope of the invention, the latter being defined by the appended claims.

1-11. (canceled)

12. A cyclone apparatus, comprising:
a cyclone body for providing swirling movement to fluid containing material in powder or granular state and processing the material and the fluid;
a preliminary swirling unit with an approximate cylindrical shaped body for providing swirling movement in the same direction as that of swirling flow in the cyclone body to the fluid containing the matter in advance; and
a connecting path for discharging the fluid previously swirled in the preliminary swirling unit from the preliminary swirling unit in a substantially tangential direction and introducing the fluid to the cyclone body in a substantially tangential direction.

13. The cyclone apparatus of claim 12, wherein the preliminary swirling unit and the cyclone body are linearly connected through the connecting path.

14. The cyclone apparatus of claim 12, wherein the connecting path includes a flat interior wall at least in an outer side thereof.

15. The cyclone apparatus of claim 13, wherein the connecting path includes a flat interior wall at least in an outer side thereof.

16. The cyclone apparatus of claim 12, further comprising a sub-cyclone.

17. The cyclone apparatus of claim 13, further comprising a sub-cyclone.

18. The cyclone apparatus of claim 14, further comprising a sub-cyclone.

19. The cyclone apparatus of claim 12, comprising a plurality of preliminary swirling units serially connected.

20. The cyclone apparatus of claim 13, comprising a plurality of preliminary swirling units serially connected.

21. The cyclone apparatus of claim 14, comprising a plurality of preliminary swirling units serially connected.

22. The cyclone apparatus of claim 15, comprising a plurality of preliminary swirling units serially connected.

23. The cyclone apparatus of claim 12, wherein, when the average internal diameter of the approximate cylindrical body for swirling fluid in the cyclone body is set at 1, an average internal diameter of an approximate cylindrical body in the preliminary swirling unit is set at 1+0.2.

24. The cyclone apparatus of claim 16, wherein, when the average internal diameter of the approximate cylindrical body for swirling fluid in the cyclone body is set at 1, an average internal diameter of an approximate cylindrical body in the preliminary swirling unit is set at 1±0.2.

25. The cyclone apparatus of claim 19, wherein, when the average internal diameter of the approximate cylindrical body for swirling fluid in the cyclone body is set at 1, an average internal diameter of an approximate cylindrical body in the preliminary swirling unit is set at 1 ±0.2.

26. The cyclone apparatus of claim 12, wherein the average internal diameters of the approximate cylindrical body for swirling fluid in the cyclone body and the approximate cylindrical body in a sub-cyclone are different.

27. The cyclone apparatus of claim 16, wherein the average internal diameters of the approximate cylindrical body for swirling fluid in the cyclone body and the approximate cylindrical body in a sub-cyclone are different.

28. The cyclone apparatus claim 12, further comprising means for reintroducing material collected in the cyclone body and a sub-cyclone into the preliminary swirling unit.

29. A preliminary swirling unit, comprising in the cyclone apparatus of claim 12.

30. A powder dust remover, comprising the cyclone apparatus of claim 12.

31. An automobile, comprising the cyclone apparatus of claim 12.
